(19) United States
(12) Patent Application Publication
(10) Pub. No.: US 2018/0088006 A1
(43) Pub. Date: Mar. 29, 2018

(54) Device and Method for Evaluating Driving Sensitivity of Vehicle

(71) Applicant: Hyundai Motor Company, Seoul (KR)

(72) Inventors: Tae Hee Lee, Hwaseong-si (KR); Si Beom Kim, Incheon (KR)

(21) Appl. No.: 15/379,000

(22) Filed: Dec. 14, 2016

(30) Foreign Application Priority Data
Sep. 27, 2016 (KR) 10-2016-0123697

(51) Int. Cl. G01M 17/06; G01M 17/04; B62D 15/02; B60R 16/023; G07C 5/00

(52) U.S. Cl. CPC G01M 17/06; G01M 17/04; E01C 23/01; B60R 16/0231; G07C 5/008; B62D 15/021

(57) ABSTRACT

A method for evaluating driving sensitivity of a vehicle is disclosed. Data associated with a vehicle driving movement is collected from various sensors mounted on a vehicle. Driving sensitivity data is measured using an electronic ear device that simulates what a passenger feels with the movement with an ear. An evaluator directly inputs sensitivity for a driving evaluation result and the sensitivity is made into data through a driving sensitivity recording device. The data associated with the vehicle driving movement, the data from the electronic ear device, and the data from the driving sensitivity recording device is matched the matched data is recorded as one pattern. The driving sensitivity is evaluated based on materials of the data storing device.

### CROSS-REFERENCE TO RELATED APPLICATIONS

This application claims under 35 U.S.C. § 119(a) the benefit of Korean Patent Application No. 10-2016-0123697 filed on Sep. 27, 2016, the entire contents of which are incorporated herein by reference.

### TECHNICAL FIELD

The present disclosure relates to a device and a method for evaluating driving sensitivity of a vehicle.

### BACKGROUND

When vehicles are developed, as an evaluation method associated with driving sensitivity personally felt by a driver and a passenger, various methods including actual driving evaluation, noise, vibration, harshness (NVH) evaluation, durability deterioration evaluation, and the like are executed.

However, the evaluation method associated with the driving sensitivity has a problem in that a lot of time is required for various evaluation preparations, and consequently, a lot of time and manpower are excessively required for evaluating the driving sensitivity of the vehicle for a long term.

Since the method for evaluating the driving sensitivity of the vehicle only depends on the sensitivity of a specific evaluator, the method has a disadvantage that consistency and accuracy deteriorate with a change in sensitivity of the evaluator and correspondingly has a problem in that a driving sensitivity evaluation result varies depending on the evaluator.

The above information disclosed in this Background section is only for enhancement of understanding of the background of the invention and therefore it may contain information that does not necessarily form the prior art that is already known in this country to a person of ordinary skill in the art.

### SUMMARY

The present disclosure relates to a device and a method for evaluating driving sensitivity of a vehicle. In particular embodiments, it relates to a device and a method for evaluating driving sensitivity of a vehicle which can accurately evaluate the driving sensitivity of the vehicle by using vehicle movement data, electronic ear data, a sensitivity evaluation result of an evaluator, and the like.

Embodiments of the present invention provide a device and a method for evaluating driving sensitivity of a vehicle which match vehicle movement data, driving sensitivity data measured by an electronic ear device, an actual sensitivity evaluation result of an evaluator, and the like one to one and record the matched data as one pattern, and construct the recorded patterns in a data storing device to accurately execute driving sensitivity evaluation throughout a whole development period of a new vehicle based on the data storing device.

The present invention also provides a device and a method for evaluating driving sensitivity of a vehicle which record driving sensitivity data by mounting a bad component in addition to a normal component associated with vehicle driving and compare the recorded driving sensitivity data with vehicle driving data of a normal state in real time to more accurately execute the driving sensitivity evaluation throughout the whole development period of the new vehicle.

In one aspect, the present invention provides a device for evaluating driving sensitivity of a vehicle. A vehicle movement data collects unit collecting data associated with a vehicle driving movement from various sensors mounted on the vehicle. An electronic ear device can measure driving sensitivity data by simulating that a passenger feels the movement with an ear. A driving sensitivity recording device records sensitivity for a driving evaluation result directly input by an evaluator as data. A measurement data recording device matches the data from the vehicle movement data collecting unit, the data from an electronic ear device, and the data from the driving sensitivity recording device and records the matched data as one pattern. A data storing device is constructed based on the data recorded in the measurement data recording device. A driving sensitivity evaluating device evaluates the driving sensitivity based on materials of the data storing device.

In a preferred embodiment, the vehicle movement data collecting unit may be configured to include a steering angle sensor, an acceleration pedal step amount sensor, a throttle position sensor (TPS), a vehicle height sensor, a yaw sensor, a braking sensor, and a velocity sensor.

In another preferred embodiment, the vehicle movement data collecting unit may further include a driving road surface selecting device capable of selecting a current driving road surface.

In still another preferred embodiment, the electronic ear device may be configured to include a microphone mounted on the periphery of an ear of a dummy mounted on a seat, and an acceleration sensor and a yaw sensor mounted on an upper body part including a head of the dummy.

In yet another preferred embodiment, the measurement data recording device may be configured to include a measurement data grouping device grouping the data from the vehicle movement data collecting unit, the data from the electronic ear device, and the data from the driving sensitivity recording device by using a statistical method, and a measurement data comparing device comparing new measurement data with pre-grouped data.

In still yet another preferred embodiment, the measurement data recording device may be configured to further include a contribution level determining device deleting a sensor value having a low contribution level to grouping among output values of the respective sensors and selecting a sensor value having a high contribution level, and a measurement data self-learning device reflecting newly measured data onto corresponding grouping data and updating the reflected data again, in the measurement data comparing device.

In a further preferred embodiment, the driving sensitivity evaluating device may include an acceptance or refusal determining device digitizing the driving sensitivity data from the data storing device and determining a refusal when the digitized value does not reach a development target value (THRESHOLD) and determining an acceptance when the digitized value is equal to or more than the development target value, and a sensitivity evaluation matching device extracting driving evaluation information through information search based on an evaluation result of the Internet or a magazine company and matching the extracted result with the corresponding vehicle.

In another aspect, the present invention provides a method for evaluating driving sensitivity of a vehicle, including: i) collecting data associated with a vehicle driving movement from various sensors mounted on the vehicle; ii) measuring driving sensitivity data by using an electronic ear device simulating that a passenger feels the movement with an ear; iii) directly inputting, by an evaluator, sensitivity for a driving evaluation result and making the sensitivity into data through a driving sensitivity recording device; iv) matching the data associated with the vehicle driving movement, the data from the electronic ear device, and the data from the driving sensitivity recording device and recording the matched data as one pattern and constructing a data storing device based on the recorded data; and v) evaluating the driving sensitivity based on materials of the data storing device.

In a preferred embodiment, in step i), driving movement information may be collected from a steering angle sensor, an acceleration pedal step amount sensor, a throttle position sensor (TPS), a vehicle height sensor, a yaw sensor, a braking sensor, and a velocity sensor.

In another preferred embodiment, in step i), selecting a current driving road surface may be further performed.

In still another preferred embodiment, the electronic ear device used in step ii) may be configured to include a microphone mounted on the periphery of an ear of a dummy mounted on a seat and an acceleration sensor and a yaw sensor mounted on an upper body part including a head of the dummy.

In yet another preferred embodiment, in step iv), the data associated with the vehicle driving movement, the data from the electronic ear device, and the data from the driving sensitivity recording device may match one another and the matched data may be recorded as one pattern and the respective data may be grouped and recorded by using a statistical method and new measurement data may be compared with pre-grouped data to be grouped.

In still yet another preferred embodiment, in step iv), deleting a sensor value having a low contribution level to grouping among output values of the respective sensors associated with the vehicle driving movement and selecting a sensor value having a high contribution level and reflecting the new measurement data onto the corresponding grouping again and updating the new measurement data may be further performed.

In a further preferred embodiment, step v) may include an acceptance or refusal determining step of digitizing the driving sensitivity data from the data storing device and determining a refusal when the digitized value does not reach a development target value (THRESHOLD) and determining an acceptance when the digitized value is equal to or more than the development target value, and a sensitivity evaluation matching step extracting driving evaluation information through googling based on an evaluation result of the Internet or a magazine company and matching the extracted result with the corresponding vehicle.

The present invention provides the following effects through the problem solving device.

First, the driving sensitivity data that the passenger feels the movement with the ear by using the electronic ear device and the sensitivity evaluation result of the evaluator match each other one to one in addition to actual vehicle movement data and are recorded as one pattern and the recorded patterns are constructed in the data storing device to thereby accurately evaluate the driving sensitivity for a new developed vehicle based on the data storing device.

Second, unlike a case where the driving sensitivity is just concentratedly evaluated at the time of initial development of the vehicle and the driving sensitivity is not evaluated in a deterioration state after durability evaluation driving in the related art, since the driving sensitivity can be continuously evaluated even after the durability evaluation driving, a degree at which the driving sensitivity varies depending on a change in durability of the vehicle can be determined during a whole development period of the vehicle.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a configuration diagram illustrating a device for evaluating driving sensitivity of a vehicle according to the present invention;

FIGS. 2 to 4 are schematic views illustrating an electronic ear device of the device for evaluating driving sensitivity of a vehicle according to the present invention; and

FIG. 5 is a flowchart illustrating a method for evaluating driving sensitivity of a vehicle according to the present invention.

Reference numerals set forth in the drawings includes reference to the following elements as further discussed below:

10: vehicle movement data collecting unit

20: electronic ear device

21: microphone

22: acceleration sensor

23: yaw sensor

30: driving sensitivity recording device

40: measurement data recording device

41: measurement data grouping device

42: measurement data comparing device

43: contribution level determining device

44: measurement data self learning device

50: data storing device

60: driving sensitivity evaluating device

61: acceptance or refusal determining device

62: sensitivity evaluation matching device

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF ILLUSTRATIVE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, preferred embodiments of the present invention will be described in detail with reference to the accompanying drawings.

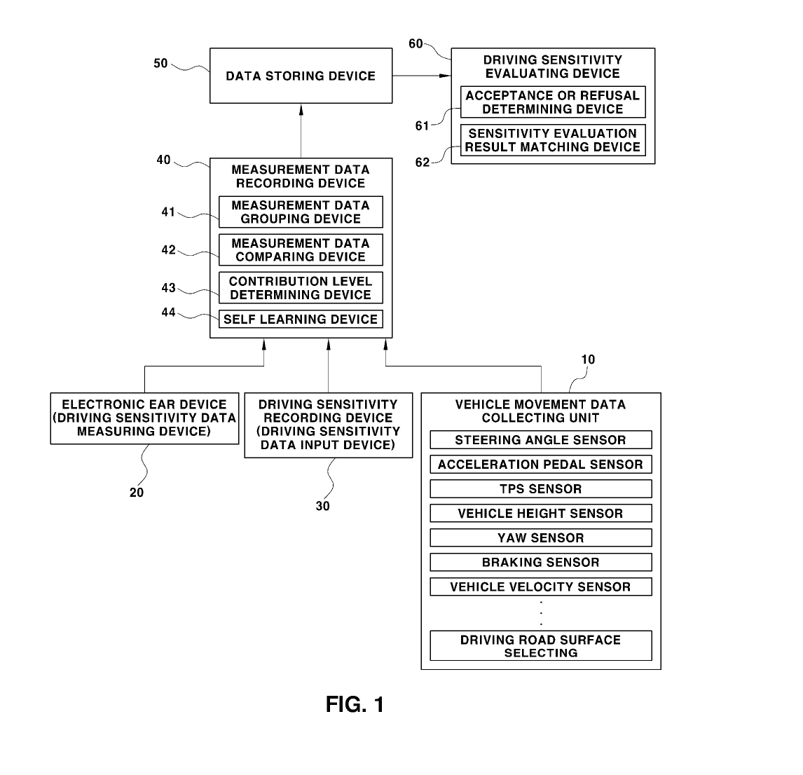

FIG. 1 is a configuration diagram illustrating a device for evaluating driving sensitivity of a vehicle according to the present invention.

The device for evaluating driving sensitivity of the present invention puts an emphasis on the point that vehicle movement data associated with the driving sensitivity, which is collected by a vehicle movement data collecting unit 10, driving sensitivity data measured by an electronic ear device 20, a sensitivity evaluation result of an evaluator, which is input through a driving sensitivity recording device 30, and the like are matched with one another and the data are recorded as one pattern and the recorded patterns are constructed in a data storing device 50 to accurately evaluate the driving sensitivity of a new developed vehicle based on the data storing device.

The vehicle movement data collecting unit 10 is a component that collects data associated with a vehicle driving movement from various sensors mounted on the vehicle and a main execution agent may be a computer, a portable electronic device, and the like which may be communicatable.

Preferably, the vehicle movement data collecting unit 10 is configured to include a steering angle sensor measuring a current steering state of a vehicle, an acceleration pedal step amount sensor and a throttle position sensor (TPS) measuring a current acceleration state of the vehicle, a vehicle height sensor measuring a ground clearance from the ground up to the vehicle, a yaw sensor measuring a yaw rate of a driving vehicle, a braking sensor for braking information, and a velocity sensor for measuring a vehicle velocity and in addition thereto, collects information from various sensors associated with a movement of the vehicle.

The vehicle movement data collecting unit 10 is configured to further include a driving road surface selecting device capable of selecting a current driving road surface and the reason is that data measured by the various sensors may vary depending on the current driving road surface.

Therefore, when a measurement operator selectively inputs the current driving road surface (an asphalt road, a concrete road, a barrier, an unpaved road, a road in which a curve is repeated, a wave road surface in which a height is repeated, and the like) in the vehicle movement data collecting unit 10 through the driving road surface selecting device, the vehicle movement data collecting unit 10 collects the vehicle movement data on the selected driving road surface from the various sensors.

The vehicle movement data collected by the vehicle movement data collecting unit 10 is transmitted to the measurement data recording device 40.

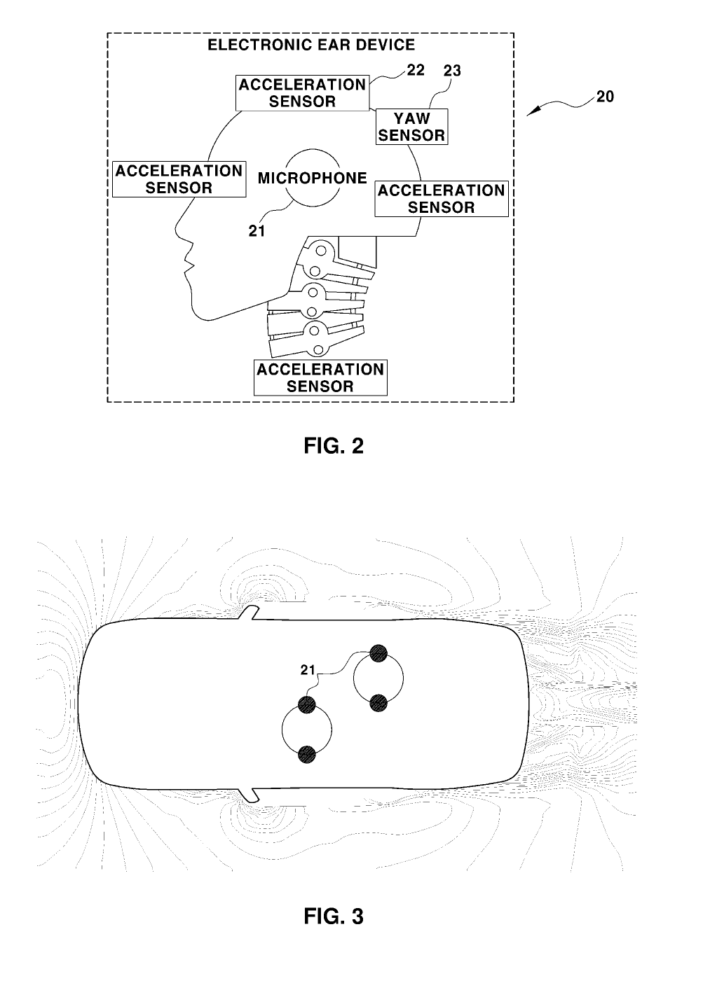

The electronic ear device 20 as a driving sensitivity data measuring device measuring the driving sensitivity data by simulating that a passenger hears and feels the movement with an ear while the vehicle is driven is configured to include a microphone 21 mounted around the ear of a dummy mounted on a seat and a plurality of acceleration sensors 22 and yaw sensors 23 mounted on an upper body part including a head of the dummy as illustrated in FIG. 2.

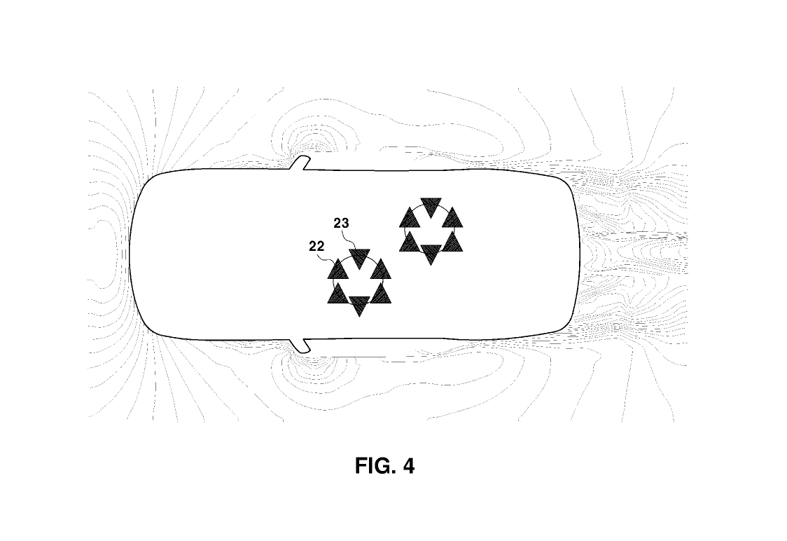

In more detail, in order to implement the electronic ear device 20, the dummy is disposed on the seat in the vehicle and thereafter, the microphone 21 is mounted around the ear of the dummy as illustrated in FIG. 3 and as illustrated in FIG. 4, the acceleration sensor 22 and the yaw sensor 23 are mounted around the head of the dummy.

In this case, each of the sensors constituting the electronic ear device 20 need not particularly be mounted on the dummy and may be mounted on a head rest of the seat, and the like.

Accordingly, the microphone 21 of the electronic ear device 20 collects current noise information while simulating a situation as if a person hears a sound during the driving of the vehicle and data measured by the acceleration sensor 22 and the yaw sensor 23 of the electronic ear device 20 is measured as movement data which the person feels during the driving.

Preferably, when each sensor constituting the electronic ear device is mounted around a seat head rest of a rear seat, the driving sensitivity at the rear seat may be evaluated and in addition, when each sensor is installed in both a front seat and the rear seat of the vehicle, the driving sensitivity data of the vehicle is more minutely secured to be made into a database.

Therefore, the electronic ear device may be implemented by mounting the microphone at a position close to the periphery of the ear of the driver or passenger at the head rest of the seat and mounting the acceleration sensor and the yaw sensor at the head rest or the peripheral position thereof.

As described above, the noise information and the movement data collected by the electronic ear device 20 are transmitted to the measurement data recording device 40.

The driving sensitivity recording device 30 as a device that records and stores sensitivity for the driving evaluation result directly input by the evaluator as data is constituted by an input unit and a storage device and the main execution agent of the driving sensitivity recording device 30 may be the computer, the portable electronic device, and the like which are communicatable.

Therefore, the evaluator gets on the vehicle in person and thereafter, the evaluator subjectively evaluates the driving sensitivity under the same vehicle driving condition in which the vehicle movement data collecting unit 10 and the electronic ear device 20 collect or measure the data associated with the driving sensitivity and inputs the sensitivity for the driving evaluation result into the driving sensitivity recording device 30, and as a result, an evaluation specialist or an ordinary person may perform an evaluation input of the driving sensitivity at this time and when the evaluation has already been completed by external evaluation institutions, that is, a magazinist, a special blogger, an authorized evaluation agency, and a press group, the evaluation result may be additionally input.

The driving evaluation data of the evaluator, which is recorded in the driving sensitivity recording device 30 is also transmitted to the measurement data recording device 40.

The measurement data recording device 40 is a device that matches the vehicle movement data from the vehicle movement data collecting unit 10, the driving sensitivity data from the electronic ear device 20, and the evaluator input data from the driving sensitivity recording device 30 one to one and records the matched data as one pattern and the main execution agent may become the communicatable computer, and the like.

To this end, the measurement data recording device 40 includes a measurement data grouping device 41 that groups (clusters) data from the vehicle movement data collecting unit 10, data from the electronic ear device 20, and data from the driving sensitivity recording device 30 by using a statistical method and a measurement data comparing device 42 comparing new measurement data with pre-grouped data.

Preferably, the measurement data recording device 40 further includes a contribution level determining device 43 that excludes a sensor value having a low contribution level to grouping among output values of the respective sensors included in the vehicle movement data collecting unit 10 and the electronic ear device 20 in the measurement data comparing device 42 and selects a sensor value having a high contribution level and further includes a measurement data self-learning device 44 updating the new measurement data in order to reflect the new measurement data onto grouping data.

Therefore, in the measurement data grouping device 41, the measurement data recording device 40 matches the data from the vehicle movement data collecting unit 10, the data from the electronic ear device 20, and the data from the driving sensitivity recording device 30 one to one by using a normal statistical method and groups the matched data as one pattern.

In this case, the one-to-one matching represents including the data from the vehicle movement data collecting unit 10, the data from the electronic ear device 20, and the data from the driving sensitivity recording device 30 in one grouping category under the same driving condition of the vehicle.

When the new measurement data is transmitted to the measurement data recording device 40, that is, when the new measurement data is transmitted from the vehicle movement data collecting unit 10, the electronic ear device 20, and the driving sensitivity recording device 30, the measurement data comparing device 42 compares the new measurement data with the data pre-grouped by the measurement data grouping device 41 to determine whether the new measurement data is similar to the pre-grouped data.

As a result of the determination, when the new measurement data is determined to be most similar to one of the pre-grouped data, the corresponding new measurement data is reflected onto one which is most similar among the pre-grouped data by the measurement data self-learning device 44 to update the pre-grouped data.

For example, when a measurement value of any one of the acceleration sensors 22 of the electronic ear device 20 is not normally output or not output at a desired level, the contribution level determining device 43 determines the acceleration sensor as an acceleration sensor having the low contribution level to the grouping and then excludes the measurement data from the corresponding acceleration sensor, while when the measurement value is normally output, the contribution level determining device 43 selects the acceleration sensor as an acceleration sensor having the high contribution level to the grouping and then continuously uses the measurement data from the corresponding acceleration sensor.

Meanwhile, as described above, the data storing device 50 is constituted based on the data recorded in the measurement data recording device 40.

In other words, the data storing device 50 is constructed by newly grouping new measurement data including data acquired by grouping the data recorded in the measurement data recording device 40, that is, the data from the vehicle movement data collecting unit 10, the data from the electronic ear device 20, and the data from the driving sensitivity recording device 30 by using the statistical method and reflecting the updated data.

The driving sensitivity evaluating device 60 evaluates the driving sensitivity based on the materials of the constructed data storing device.

The driving sensitivity evaluating device 60 is constituted by an acceptance or refusal determining device 61 deciding determination of acceptance or refusal for the driving sensitivity and a sensitivity evaluation matching device 62 for using external information other than the materials of the data storing device for evaluating the sensitivity and the main execution agent may become the communicatable computer.

Accordingly, the acceptance or refusal determining device 61 digitizes the driving sensitivity data from the data storing device 50 by using a predetermined program and thereafter, determines a refusal when the digitized value does not reach a development target value (THRESHOLD) and determines an acceptance when the digitized value is equal to or more than the development target value.

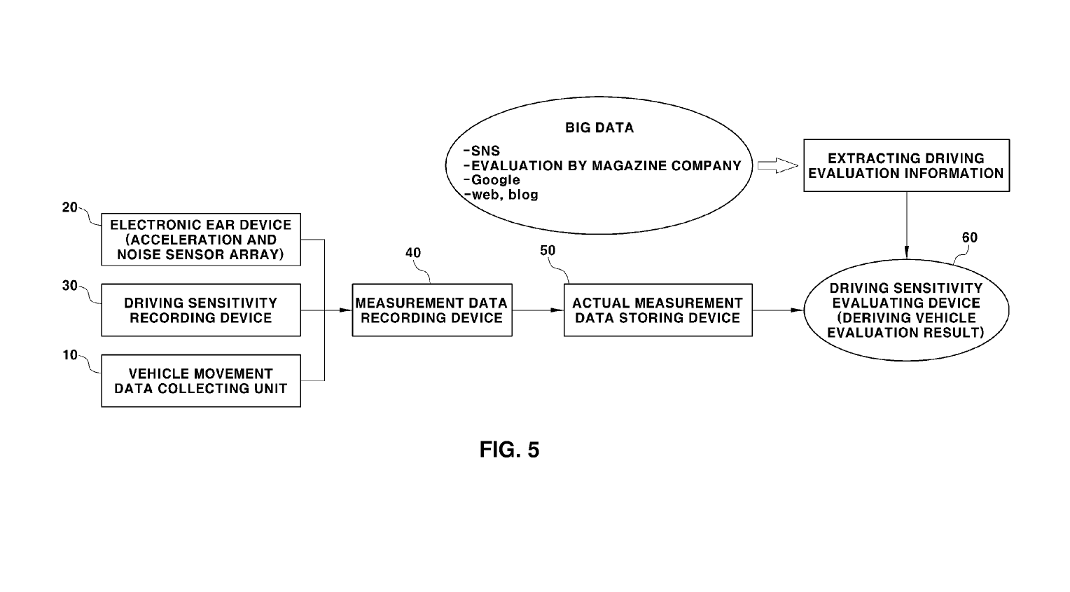

The sensitivity evaluation matching device 62 extracts evaluation information for a vehicle type of a driving sensitivity evaluation target from the Internet (SNS, Google, and other webs and blogs) or a magazine company evaluation result (e.g., vehicle type “A” is very instable in suspension on an expressway—Magazine B, driving sensitivity related evaluation information of vehicle type “A” extracted through information search, and the like) and makes the extracted evaluation information into big data as illustrated in FIG. 5.

The result extracted by the sensitivity evaluation matching device 62 matches the corresponding vehicle to be used as the sensitivity evaluation result.

For example, the result that vehicle type “A” is very instable in suspension on the expressway matches the data (the driving sensitivity data measured on the expressway) present in the data storing device to be used as the sensitivity evaluation result.

As described above, the driving sensitivity data which the passenger feels with the ear by using the electronic ear device and the sensitivity evaluation result of the evaluator match each other one to one in addition to actual vehicle movement data and are recorded as one pattern and the recorded patterns are constructed in the data storing device to thereby accurately evaluate the driving sensitivity during the development period of a new vehicle based on the data storing device.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A device for evaluating driving sensitivity of a vehicle, the device comprising:
a vehicle movement data collecting unit configured to collect data associated with a vehicle driving movement from various sensors mounted on a vehicle;
an electronic ear device configured to measure driving sensitivity data;
a driving sensitivity recording device configured to record sensitivity for a driving evaluation result directly input by an evaluator as data;
a measurement data recording device configured to match the data from the vehicle movement data collecting unit, the data from the electronic ear device, and the data from the driving sensitivity recording device and to record the matched data as one pattern;
a data storing device constructed based on the data recorded in the measurement data recording device; and
a driving sensitivity evaluating device configured to evaluate the driving sensitivity based on materials of the data storing device.

2. The device of claim 1, wherein the vehicle movement data collecting unit comprises a steering angle sensor, an acceleration pedal step amount sensor, a throttle position sensor (TPS), a vehicle height sensor, a yaw sensor, a braking sensor, and a velocity sensor.

3. The device of claim 2, wherein the vehicle movement data collecting unit further comprises a driving road surface selecting device capable of selecting a current driving road surface.

4. The device of claim 1, wherein the electronic ear device comprises:
a microphone mounted on the periphery of an ear of a dummy mounted on a seat; and
an acceleration sensor and a yaw sensor mounted on an upper body part including a head of the dummy.

5. The device of claim 1, wherein the electronic ear device comprises:
a microphone mounted at a position close to the periphery of the ear of a driver or passenger at a head rest of a seat; and
an acceleration sensor and a yaw sensor mounted at the head rest or a peripheral position thereof.

6. The device of claim 1, wherein the measurement data recording device comprises:
a measurement data grouping device configured to group the data from the vehicle movement data collecting unit, the data from the electronic ear device, and the data from the driving sensitivity recording device by using a statistical method; and
a measurement data comparing device configured to compare new measurement data with pre-grouped data.

7. The device of claim 6, wherein the measurement data recording device comprises:
a contribution level determining device configured to delete a sensor value having a low contribution level to grouping among output values of the respective sensors and to select a sensor value having a high contribution level; and
a measurement data self-learning device configured to reflect newly measured data onto corresponding grouping data and updating the reflected data again, in the measurement data comparing device.

8. The device of claim 1, wherein the driving sensitivity evaluating device comprises:
an acceptance or refusal determining device configured to derive a digitized value from the driving sensitivity data from the data storing device and to determine a refusal when the digitized value does not reach a development target value and to determine an acceptance when the digitized value is equal to or more than the development target value; and
a sensitivity evaluation matching device configured to extract driving evaluation information of the Internet or a magazine company and to match the extracted driving evaluation information with a corresponding vehicle.

9. The device of claim 1, wherein the driving sensitivity recording device comprises an input unit in a storage device configured to record and store sensitivity for a driving evaluation result directly input by an evaluator as data.

10. A method for evaluating driving sensitivity of a vehicle, the method comprising:
collecting data associated with a vehicle driving movement from various sensors mounted on a vehicle;
measuring driving sensitivity data by using an electronic ear device that simulates what a passenger feels with the movement with an ear;
directly inputting, by an evaluator, sensitivity for a driving evaluation result;
making the sensitivity into data through a driving sensitivity recording device;
matching the data associated with the vehicle driving movement, the data from the electronic ear device, and the data from the driving sensitivity recording device and recording the matched data as one pattern;
constructing a data storing device based on the recorded data; and
evaluating the driving sensitivity based on materials of the data storing device.

11. The method of claim 10, wherein collecting the data comprises collecting driving movement information is collected from a steering angle sensor, an acceleration pedal step amount sensor, a throttle position sensor (TPS), a vehicle height sensor, a yaw sensor, a braking sensor, and a velocity sensor.

12. The method of claim 10, further comprising selecting a current driving road surface when the collecting the data.

13. The method of claim 10, wherein the electronic ear device comprises a microphone mounted on the periphery of an ear of a dummy mounted on a seat and an acceleration sensor and a yaw sensor mounted on an upper body part including a head of the dummy.

14. The method of claim 10, wherein the data associated with the vehicle driving movement, the data from the electronic ear device, and the data from the driving sensitivity recording device match one another and the matched data is recorded as one pattern and each of the data is grouped and recorded by using a statistical method and new measurement data is compared with pre-grouped data to be grouped.

15. The method of claim 10, wherein the matching comprises deleting a sensor value having a low contribution level to grouping among output values of the respective sensors associated with the vehicle driving movement, selecting a sensor value having a high contribution level and reflecting new measurement data onto the corresponding grouping again, and updating the new measurement data.

16. The method of claim 10, wherein evaluating the driving sensitivity comprises:
digitizing the driving sensitivity data from the data storing device to obtain a digitized value;
determining a refusal when the digitized value does not reach a development target value and determining an acceptance when the digitized value is equal to or more than the development target value; and
extracting driving evaluation information of the Internet or a magazine company and matching the extracted driving evaluation information with a corresponding vehicle.
